(19) United States
(12) Patent Application Publication
(10) Pub. No.: US 2026/0168654 A1
(43) Pub. Date: Jun. 18, 2026

(54) ADAPTABLE TRACK LIGHTING SYSTEM

(71) Applicant: SIGNIFY HOLDING B.V., EINDHOVEN (NL)

(72) Inventors: TIES VAN BOMMEL, HORST (NL); ROBERT JACOB PET, WAALRE (NL)

(21) Appl. No.: 18/656,837

(22) PCT Filed: Nov. 7, 2022
(86) PCT No.: PCT/EP2022/080906

§ 371 Date: May 7, 2024

(30) Foreign Application Priority Data
Nov. 8, 2021 (EP) 21206891.0

(51) Int. Cl. F21V 21/005; F21S 8/06

(52) U.S. Cl. CPC F21V 21/005; F21S 8/066

(57) ABSTRACT

The present invention relates to a power track (2) having a length (Lt) in a longitudinal extension (L) and comprising a cavity (12) enclosed by a base portion (3), a first leg portion (4) and a second leg portion (5) and having an open side (13). The track (2) has an inner portion (7) constituted by the cavity (12). The first and the second leg portions (4, 5) are substantially parallel to each other and are connected by the base portion (3). The first and the second leg portions (4, 5) have a longitudinal extension being substantially parallel to the longitudinal extension of the power track (2), and a transversal extension (T1) being substantially perpendicular to the longitudinal extension, such that the track (2) has a substantially U-shaped cross-section in a direction being substantially perpendicular to the longitudinal extension. The track (2) comprises electrical and mechanical connection means. The power track (2) comprises at least one LED module (6) providing module light having a spatial light distribution and a spectral light distribution, wherein the LED module (6) is connectable to the track (2) in a first orientation (O1) for providing indirect module light (M2) in a first direction and in a second orientation (O2) for providing direct module light (M1) in a second direction. The inner portion (7) of the track (2) is arranged to at least partially accommodate the at least one LED module (6), and an outer portion (8) of the track (2) is arranged to be mounted to a support surface; wherein the track (2) comprises at least one elongated translucent optical component (9) for transmitting indirect module light (M2) when the LED module (6) is in the

### TECHNICAL FIELD

The present invention relates to a track lighting system comprising a substantially U-shaped power track and at least one LED module being connectable to the power track. Further, the present invention relates to a method for controlling such a track lighting system.

### BACKGROUND

Setting a correct light in an interior environment is of large importance. First of all, a correctly illuminated room is perceived by the user as attractive and pleasant to reside. Thus, in an industrial site or in a workshop, the light setting may be used for providing conditions in which the operators have a clear view of objects that they are working on. This is particularly important when objects comprise small parts to be assembled, or when the operator has to perform the work in an obstructed environment, such as under a vehicle or the like. In a home environment, it may be desirable to adapt the lighting conditions to the activity of subjects residing a room.

A lighting system used in an interior environment should be highly adaptable, giving the user possibility adapt the light setting to a current situation.

Lighting systems addressing some of the aspects above are track lighting systems, wherein luminaires are fitted on tracks. Such lighting systems provide great flexibility and adaptability, since the number as well as positioning of the luminaires along the track may be varied. However, there is a need for providing an increased adaptability of track lighting systems, wherein the user may select different operating conditions of the track lighting system, depending on the current needs.

EP3882513 A1 discloses a lighting system comprising a lighting bar and at least one lighting device couplable to the lighting bar. The lighting bar accommodates a linear lighting source. Each lighting device is provided with at least one pair of arms for anchoring to the bar and with electrical connection needles suitable to create an electrical contact with the electrical power supply line obtained in the electronic board of the linear lighting source.

In US 2018/224104 a modular overhead lighting system is disclosed that includes a raceway element and one or more interchangeable lighting modules capable of variable positioning relative to the raceway element. Multiple raceway conductors are mounted in the raceway element, with a portion of each raceway conductor being exposed along a lower surface thereof to facilitate continuously variable positioning of lighting modules. An electrical connector for establishing electrical connections between a raceway element and a lighting module includes multiple ridges incorporating electrical contacts configured to contact raceway conductors and includes terminals to removably receive electrical wires permitting electrical communication between a lighting module and the raceway element.

U.S. Pat. No. 4,999,755 discloses a tube light that comprises a tube having a continuous length, and a plurality of light units which conform to the inner configuration of the tube and can suitably be positioned anywhere in the tube. Conductor strips which are adapted to be connected with a power supply are disposed in parallel in the tube whereby the bulbs of the light units are engaged by contacting of the conductor strips with the contacts of the light units. The light tube is simple in structure and can be loaded with a suitable number of the light units in optional locations.

### SUMMARY

The object of the present invention is to provide such a track lighting system. The track lighting system according to the present invention thus comprises a power track having a length (Lt) in a longitudinal extension, and a transverse extension being perpendicular to the longitudinal extension. The power track comprises a cavity enclosed by a base portion, a first leg portion and a second leg portion and having an open side. The track has an inner portion constituted by the cavity. The first and the second leg portions are substantially parallel to each other and are arranged at a distance from each other in the transverse direction being parallel to the transverse extension of the power track. The first and the second leg portions are connected by the base portion. The base portion of the track may be a metal portion, thus providing sufficient robustness and strength to the track.

The first and the second leg portions have a longitudinal extension being substantially parallel to the longitudinal extension of the power track. The first and the second leg portions may be continuous or intermittent. By the term “substantially parallel” is in the context of the present invention understood as being parallel or deviating from the parallel by not more than 10°. The first and the second leg portions further have a transversal extension being substantially perpendicular to the longitudinal extension, such that the track has a substantially U-shaped cross-section in a direction being substantially perpendicular to the longitudinal extension. By the term “substantially perpendicular” is understood that the angle between the transversal extension of the first and the second leg portions and the longitudinal extension of the track is 90° or deviating from 90° by not more than 20°, such as 10°. In other words, the angle between each of the first and second leg portions and the base portion of the track may be from 70° to 110°. The distance between the first leg portion and the second leg portion of the track may be from 1 cm to 10 cm.

The power track is connectable to a power supply, such as a public grid, a solar cell plant or the like. The track comprises electrical and mechanical connection means. The electrical connection means may be a pin contact, a socket, an inductive plate, or the like. The mechanical connection means may be a clamp, a hook, or the like. The electrical connection means and the mechanical connection means may be different. Alternatively, the electrical connection means and the mechanical connection means may be the same means, preferably comprised in one integral part. Such an integral part may extend along substantially entire longitudinal extension of the track.

The power track is arranged to provide electric output. The power track according to the present invention may be automatically or manually controlled. The automatic control may be dependent on the natural light conditions in the room, or on the predefined period of time when the track lighting system should be operating, e.g. during normal working hours. In other words, the automatic control of the power track may determine whether the power track will provide electric output, and if so, of what magnitude. The track lighting system of the present invention further comprises at least one LED module providing module light having a spatial light distribution and a spectral light distribution. The at least one LED module has a longitudinal extension being parallel to the longitudinal extension of the track, and a transverse extension being perpendicular to the longitudinal extension. It should be noted that the transverse extension of the LED module should not exceed the distance between the first and the second leg portions of the track, such that at least a portion of the LED module may be inserted into the cavity of the track. The longitudinal extension of the at least one LED module may be substantially equal to the length of the track. Alternatively, the track lighting system may comprise a plurality of LED modules, wherein the longitudinal extension of each LED module is below the length of the track. The total longitudinal extension of all the LED modules connected to the track may than be substantially equal to the length of the track.

The track lighting system of the present invention may comprise a plurality of individually controllable LED modules. In particular, the track lighting system may comprise from 1 to 20 LED modules. Each LED module of the plurality of LED modules is connectable to the power track. By the term “connectable” is in the context of the present invention meant at least mechanically or both mechanically and electrically connectable.

Mechanical connection implies a direct contact between the LED module and the power track. Mechanical connection may be provided by means of at least one fastening element, such a clip or the like. Electrical connection may be provided by means of an electrical connection element, such as plug-and-socket or a pin contact. Alternatively, electrical connection may be achieved wirelessly, e.g. through induction. If the LED module is only mechanically connected to the power track, the electrical power supply to LED module may be provided by an external power supply source, such as a disposable or rechargeable battery. Preferably, the LED module is both mechanically and electrically connected to the power track.

The shape of the at least one LED module may vary depending on the shape of the track. Thus, the at least one LED module may be substantially cuboid.

The LED module comprises at least one LED light source. The term “LED light source” implies any LED light source known in the art, including a laser light source.

The LED module may comprise a plurality of LED light sources. Further, the track lighting system may comprise a plurality of LED modules. By the term “plurality” is in the context of the present invention understood as at least two.

The LED module may be arranged for providing a visible light having a dominant peak wavelength from 380 nm to 700 nm. Further, the LED module may comprise a first group of LED light sources providing a first light having a first dominant peak wavelength, and a second group of LED light sources providing a second light having a second dominant peak wavelength, wherein the first dominant peak wavelength is different from the second light having a second dominant peak wavelength.

The LED module is connectable to the track in a first orientation for providing indirect module light in a first direction and in a second orientation for providing direct module light in a second direction. The term “connectable” as used herein implies at least mechanically or electrically connectable. Preferably, the LED module is both electrically and mechanically connectable to the track, such that the track fixates the LED module in position and provides electric power to the LED module. If the LED module is only mechanically connectable to the power track, the LED module may be powered by means of a disposable or rechargeable battery.

It is further conceivable that the LED module may be connectable to the track in a third orientation for providing module light in a third direction, and in a fourth orientation for providing module light in a fourth direction.

The direct module light and/or indirect module light may be white light. The white light preferably has a correlated color temperature in a range from 2000 to 8000 K. The white light has preferably a CRI of at least 80. The direct module light may be different from the indirect module light e.g. in terms of color point and/or correlated color temperature.

The first and the second leg portions of the power track may have a degree of flexibility in order to facilitate insertion of the LED module.

The inner portion of the track is arranged to at least partially accommodate the at least one LED module in any of orientations mentioned above, and an outer portion is arranged to be mounted to a support surface. The support surface may be a ceiling, a shelf, or the like. The first direction may face the inner portion of the track, and the second direction may face away from the inner portion of the power track.

The track according to the present invention further comprises at least one elongated translucent optical component for providing indirect module light when the LED module is in the first orientation. By the term “elongated” is understood as having an extension in one direction being substantially greater than the extension any other direction. In other words, the module light emitted by the LED module being in the first orientation is injected into the inner portion of the power track and is allowed to exit the power track through the at least one elongated translucent optical component. In other words, the elongated translucent optical component functions as a light exit window when the LED module is in the first orientation.

The track may comprise a plurality of elongated translucent optical components spaced apart along the longitudinal extension of the track. The elongated translucent optical components may be evenly distributed along the longitudinal extension of the track or may be concentrated in particular areas of the track depending on the intended application. For instance, each of the first leg portion and the second leg portion may comprise a first end portion arranged to be attached to the base portion, and a second end portion arranged at a distance from the base portion. The elongated translucent optical component may then be arranged in the second end portion of the first and/or the second leg portion.

The elongated translucent optical component has a length (Lo) in the longitudinal extension of the track. The length of the translucent optical component may fulfill the inequality Lo 24 0.8·Lt. It is also conceivable that Lo is approximately equal to Lt, or that Lo is equal to Lt. When the track comprises a plurality of elongated translucent optical components, the total length of all the elongated translucent optical components may be at least 80% of the length of the track. In such an embodiment, a proper amount of indirect module light may be emitted by the track lighting system.

The elongated translucent optical component may be arranged in at least a portion of at least one of the first leg portion and the second leg portion. In particular, the track may comprise a plurality of elongated translucent optical components being arranged in both the first and the second leg portions. It is further conceivable that the base portion and the first and the second leg portions of the power track constitute the elongated translucent optical component. In other words, the entire track may be manufactured of the elongated translucent optical component. Further, the first leg portion and/or the second leg portion may comprise an elongated translucent optical component and may further comprise a metal portion. Such an embodiment offers the advantage of improved stability and robustness of the track. The metal portions of the first and the second leg portions and the base portion made of metal may be in the form of a monolithic U-shaped profile.

According to the present invention, the elongated translucent optical component may be a diffuser. The diffuser may preferably have a reflectance in a range from 20 to 80%, more preferably from 30 to 70%, most preferably from 35 to 65%. Such an embodiment provides the advantage of improved homogeneity of illumination.

The diffuser may preferably have a transmission in a range from 20 to 80%, more preferably from 30 to 70%, most preferably from 35 to 65%. Such an embodiment provides the advantage of improved homogeneity of illumination.

The portion of the track other than the elongated translucent optical component may comprise a reflective portion. The reflective portion may be an extruded metal portion, and may have reflectivity of at least 75%, preferably at least 80%, more preferably at least 85%, most preferably at least 88%. The metal may be selected from aluminium, iron, copper, and combinations thereof.

The track may comprise a first section and a second section being mechanically connected to each other. The first and the second sections may be extruded.

The material of the first section of the track may be same as or different from the material of the second section of the track. In particular, the first section may be manufactured from metal, while the second section may be manufactured from plastic. The plastic may be selected from PMMA, PC, PET, PS, and combinations thereof. In such an embodiment, the elongated translucent optical component may be arranged in the second section of the track, while the first section of the track may be free from the elongated translucent optical component. In particular, the second section of the track may constitute the elongated translucent optical component.

It should be noted that the elongated translucent optical component of the power track is preferably free from mechanical and/or electrical connection elements.

The first section of the track may have a first length in the longitudinal extension, and the second section of the track may have a second length in the longitudinal extension. The first length may be same as or different from the second length.

The track lighting system according to the present invention may further comprise a controller for controlling the spatial light distribution and/or the spectral light distribution from a first parameter to a second parameter different from the first parameter.

The first parameter of the spatial light distribution and/or the spectral light distribution may be applied when the LED module is in the first orientation, and the second parameter of the spatial light distribution and/or second spectral light distribution may be applied when the LED module is in the second orientation.

According to the present invention, at least 60% of the indirect module light is emitted into the cavity of the track through the open side of the track when the LED module is in the first orientation. Such an embodiment offers the advantage of proper light injection. The LED module preferably comprises a light exit window arranged to face the inner portion of the track when the LED module in in the first orientation. Further, the light exit window is arranged to face away from the inner portion of the track when the LED module is in the second orientation. In other words, when the LED module is in the first orientation, the light emitted by the LED module and exiting through the light exit window will be directed towards the inner portion of the track and will be emitted through the elongated translucent optical component, thus providing indirect module light. Such an indirect module light may be desirable when soft background lighting of a space is required. On the other hand, when the LED module is in the second orientation, the light emitted by the LED module and exiting through the light exit window will be directed towards the ambient, i.e. towards the space to be illuminated, thus providing direct module light. Such a direct module light may be desirable when bright and sharp lighting of a space is required. In view of the above, it is evident that the track lighting system according to the present invention provides a superior flexibility and adaptability, allowing the user to select the orientation of the LED module, thus adapting module light to the current situation.

The light exit window of the LED module may be completely covered by the track when the LED module is in the first orientation. In such an embodiment, all light emitted by the LED module will be inserted into the inner portion of the track and will be emitted through the elongated translucent optical component as indirect module light.

Therefore, no mixture of direct and indirect module light will be present, thus improving quality of module light provided by the track lighting system. The distance between the light exit window and the inner portion of the track may be equal to or below 2 cm.

The present invention further relates to a method for controlling a track lighting system as described above. The method of the present invention comprises the steps of:
a) determining whether indirect module light (M1) should be provided in a first direction (D1) or direct module light (M2) should be provided in the second direction (D2);
b) attaching the LED module to the track in either the first orientation or the second orientation depending on the direction of the light determined in step a).

As described above, the user may determine whether direct module light or indirect module light is desired and attached the LED module in the orientation that provides desired module light.

### BRIEF DESCRIPTION OF THE DRAWINGS

Embodiments of the invention will now be described by way of example with reference to the accompanying drawings, of which:

FIG. 1a is a cross-sectional view of the track lighting system of the present invention, wherein LED module is in the second orientation;

FIG. 1b is a cross-sectional view of the track lighting system depicted in FIG. 1a, wherein LED module is in the first orientation;

FIG. 2a is a cross-sectional view of the track lighting system according to another embodiment of the present invention, wherein LED module is in the second orientation;

FIG. 2b is a cross-sectional view of the track lighting system depicted in FIG. 2a, wherein LED module is in the first orientation;

All the figures are schematic, not necessarily to scale, and generally only show parts which are necessary in order to elucidate embodiments of the present invention, wherein other parts may be omitted or merely suggested.

### DETAILED DESCRIPTION

The present invention will now be described hereinafter with reference to the accompanying drawings, in which exemplifying embodiments of the present invention are shown. The present invention may, however, be embodied in many different forms and should not be construed as limited to the embodiments of the present invention set forth herein; rather, these embodiments of the present invention are provided by way of example so that this disclosure will convey the scope of the invention to those skilled in the art. In the drawings, identical reference numerals denote the same or similar components having a same or similar function, unless specifically stated otherwise.

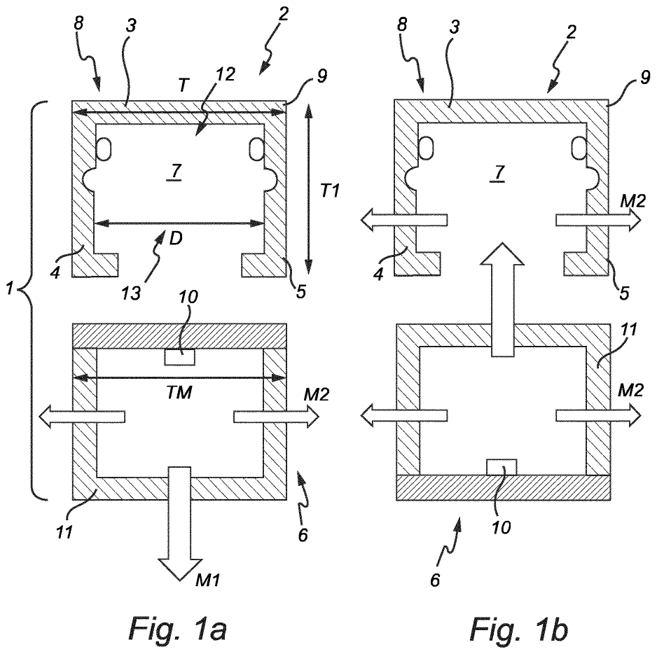

FIGS. 1a and 1b illustrate a track lighting system 1 according to the present invention. The track lighting system 1 comprises a power track 2 having a length Lt in a longitudinal extension L (not shown) and a transverse extension T being perpendicular to the longitudinal extension L. The power track 2 comprises a cavity 12 enclosed by a base portion 3, a first leg portion 4 and a second leg portion 5 and having an open side 13. The track 2 has an inner portion 7 constituted by the cavity 12. The first and the second leg portions 4, 5 are substantially parallel to each other and are arranged at a distance D from each other in the transverse direction being parallel to the transverse extension T of the power track. The first and the second leg portions 4, 5 are connected by the base portion 3. The first and the second leg portions 4, 5 have a longitudinal extension being substantially parallel to the longitudinal extension of the power track. The first and the second leg portions may be continuous or intermittent. The first and the second leg portions further have a transversal extension T1 being substantially perpendicular to the longitudinal extension, such that the track 2 has a substantially U-shaped cross-section in a direction being substantially perpendicular to the longitudinal extension.

The track lighting system 1 further comprises a LED module 6 providing module light having a spatial light distribution and a spectral light distribution. The LED module 6 has a longitudinal extension being parallel to the longitudinal extension of the track 2, and a transverse extension TM being perpendicular to the longitudinal extension. As may be seen in FIGS. 1a and 1b, the transverse extension TM of the LED module 6 should not exceed the distance D between the first and the second leg portions 4, 5 of the track 2, such that at least a portion of the LED module 6 may be inserted in the track 2. The LED module 6 comprises at least one LED light source 10.

The LED module 6 is connectable to the track 2 in a first orientation O1 shown in FIG. 1b for providing indirect module light M2 in a first direction and in a second orientation 02 depicted in FIG. 1a for providing direct module light M1 in a second direction. The first and the second leg portions 4, 5 of the power track 2 may have a degree of flexibility in order to facilitate insertion of the LED module 6.

The inner portion 7 of the track 2 is arranged to at least partially accommodate the LED module 6 in any of orientations mentioned above, and an outer portion 8 is arranged to be mounted to a support surface. The support surface may be a ceiling, a shelf or the like. The track 2 according to the present invention comprises a base portion 3 and the first and the second leg portions 4, 5 of the power track 2 constituting an elongated translucent optical component 9. In other words, the entire track 2 is manufactured of the elongated translucent optical component 9. The elongated translucent optical component 9 is arranged for providing indirect module light M2 when the LED module 6 is in the first orientation O1, as shown in FIG. 1b. In other words, the module light emitted by the LED module 6 being in the first orientation O1 is injected into the inner portion 7 of the power track 2 and is allowed to exit the power track 2 through the elongated translucent optical component 9. Thus, the elongated translucent optical component 9 functions as a light exit window when the LED module is in the first orientation O1.

As mentioned above, at least 60% of the indirect module light M2 is emitted into the cavity 12 of the track 2 through the open side 13 of the track 2 when the LED module 6 is in the first orientation O1. Such an embodiment offers the advantage of proper light injection.

The LED module 6 comprises a light exit window 11 arranged to face the inner portion 7 of the track 2 when the LED module 6 in in the first orientation O1. Further, the light exit window 11 is arranged to face away from the inner portion 7 of the track 2 when the LED module is in the second orientation O2. In other words, when the LED module 6 is in the first orientation O1, the light emitted by the LED module and exiting through the light exit window 11 will be directed towards the inner portion 7 of the track 2 and will be emitted through the elongated translucent optical component 9, thus providing indirect module light M2. Such an indirect module light M2 may be desirable when soft background lighting of a space is required. On the other hand, when the LED module 6 is in the second orientation O2, the light emitted by the LED module 6 and exiting through the light exit window 11 will be directed towards the ambient, i.e. towards the space to be illuminated, thus providing direct module light M1. Such a direct module light M1 may be desirable when bright and sharp lighting of a space is required. In view of the above, it is evident that the track lighting system 1 according to the present invention provides a superior flexibility and adaptability, allowing the user to select the orientation of the LED module 6, thus adapting module light to the current situation.

As may be seen in FIG. 1a, the light provided by the track lighting system 1 when the LED module is in the second orientation O2 is a mixture of direct module light M1 and indirect module light M2 exiting through the elongated translucent optical component 9 arranged in the first and the second leg portions 4, 5 of the track 2.

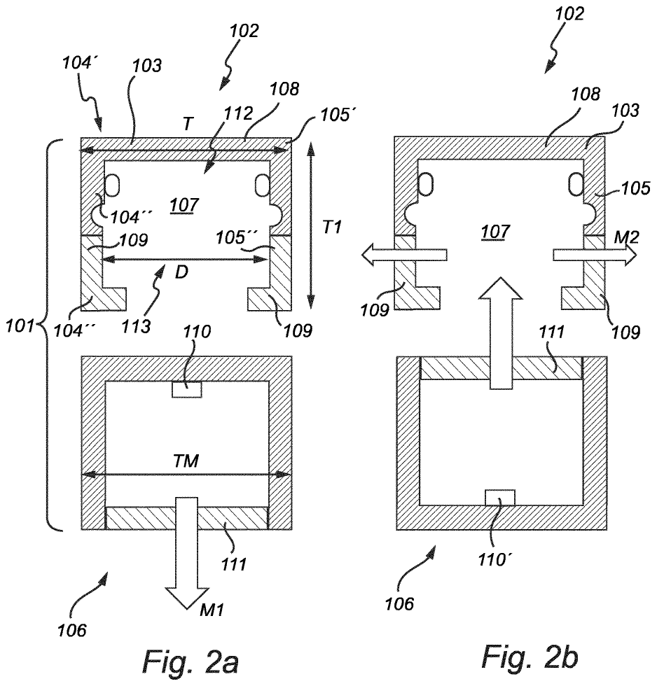

FIGS. 2a and 2b illustrate a track lighting system 101 according another embodiment of the present invention. The track lighting system 101 comprises a power track 102 having a longitudinal extension L (not shown) and a transverse extension T being perpendicular to the longitudinal extension L. The power track 102 comprises a cavity 112 enclosed by a base portion 103, a first leg portion 104 and a second leg portion 105 and having an open side 113. The first and the second leg portions 104, 105 are substantially parallel to each other and are arranged at a distance D from each other in the transverse direction being parallel to the transverse extension T of the power track. The first and the second leg portions 104, 105 are connected by the base portion 103. The first and the second leg portions 104, 105 have a longitudinal extension being substantially parallel to the longitudinal extension of the power track. The first and the second leg portions 104, 105 may be continuous or intermittent. The first and the second leg portions 104, 105 further have a transversal extension T1 being substantially perpendicular to the longitudinal extension, such that the track 102 has a substantially U-shaped cross-section in a direction being substantially perpendicular to the longitudinal extension.

The track lighting system 101 further comprises a LED module 106 providing module light having a spatial light distribution and a spectral light distribution. The LED module 106 has a longitudinal extension being parallel to the longitudinal extension of the track 102, and a transverse extension TM being perpendicular to the longitudinal extension. As may be seen in FIGS. 2a and 2b, the transverse extension TM of the LED module 106 should not exceed the distance D between the first and the second leg portions 104, 105 of the track 2, such that at least a portion of the LED module 106 may be inserted in the track 102. The LED module 106 comprises at least one LED light source 110.

The LED module 106 is connectable to the track 102 in a first orientation O1 shown in FIG. 2b for providing indirect module light M2 in a first direction and in a second orientation O2 depicted in FIG. 2a for providing direct module light M1 in a second direction. The first and the second leg portions 104, 105 of the power track 102 may have a degree of flexibility in order to facilitate insertion of the LED module 106.

The inner portion 107 of the track 102 is arranged to at least partially accommodate the LED module 6 in any of orientations mentioned above, and an outer portion 108 arranged to be mounted to a support surface. The support surface may be a ceiling, a shelf or the like.

As may be seen in FIGS. 2a and 2b, each of the first leg portion 104 and the second leg portion 105 comprises a first end portion 104′, 105′arranged to be attached to the base portion 103, and a second end portion 104″, 105″ arranged at a distance from the base portion 103. The elongated translucent optical component 9 is arranged in the second end portion 104″, 105″ of the first and the second leg portion 104, 105.

The elongated translucent optical component 109 is arranged for providing indirect module light M2 when the LED module 106 is in the first orientation O1, as shown in FIG. 2b. In other words, the module light emitted by the LED module 106 being in the first orientation O1 is injected into the inner portion 107 of the power track 102 and is allowed to exit the power track 102 through the elongated translucent optical component 109. Thus, the elongated translucent optical component 109 functions as a light exit window when the LED module 106 is in the first orientation O1.

The LED module 106 comprises a light exit window 111 arranged to face the inner portion 107 of the track 102 when the LED module 106 in in the first orientation O1.

Further, the light exit window 111 is arranged to face away from the inner portion 107 of the track 102 when the LED module 106 is in the second orientation O2. In other words, when the LED module 106 is in the first orientation O1, the light emitted by the LED module 106 and exiting through the light exit window 111 will be directed towards the inner portion 107 of the track 102 and will be emitted through the elongated translucent optical component 109, thus providing indirect module light M2. Such an indirect module light M2 may be desirable when soft background lighting of a space is required. On the other hand, when the LED module 106 is in the second orientation 02, the light emitted by the LED module 106 and exiting through the light exit window 111 will be directed towards the ambient, i.e. towards the space to be illuminated, thus providing direct module light M1. Such a direct module light M1 may be desirable when bright and sharp lighting of a space is required.

As may be seen in FIG. 2b, the light exit window 111 of the LED module 106 is completely covered by the track 102 when the LED module 106 is in the first orientation O1. In such an embodiment, all light emitted by the LED module 106 will be inserted into the inner portion 107 of the track 102 and will be emitted through the elongated translucent optical component 109 as indirect module light M2. On the other hand, the light emitted by the LED module 106 being in the second orientation O2, as shown in FIG. 2a, will be emitted as direct module light M1. Therefore, no mixture of direct and indirect module light will be present, thus improving quality of module light provided by the track lighting system 101.

Although the present invention has been described with reference to various embodiments, those skilled in the art will recognize that changes may be made without departing from the scope of the invention. It is intended that the detailed description be regarded as illustrative and that the appended claims including all the equivalents are intended to define the scope of the invention. While the present invention has been illustrated in the appended drawings and the foregoing description, such illustration is to be considered illustrative or exemplifying and not restrictive; the present invention is not limited to the disclosed embodiments. Other variations to the disclosed embodiments can be understood and effected by those skilled in the art in practicing the claimed invention, from a study of the drawings, the disclosure, and the appended claims. In the appended claims, the word “comprising” does not exclude other elements or steps, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. A track lighting system comprising:
a power track having a length in a longitudinal extension, said power track comprising a cavity enclosed by a base portion, a first leg portion and a second leg portion and having an open side said track having an inner portion constituted by said cavity wherein said first and said second leg portions, are substantially parallel to each other and are connected by said base portion, said first and said second leg portions, having a longitudinal extension being substantially parallel to said longitudinal extension of said power track, and a transversal extension being substantially perpendicular to said longitudinal extension, such that said track has a substantially U-shaped cross-section in a direction being substantially perpendicular to said longitudinal extension, said track comprising electrical and mechanical connection means;
at least one LED module providing module light having a spatial light distribution and a spectral light distribution, wherein said LED module is connectable to said track in a first orientation for providing indirect module light in a first direction and in a second orientation for providing direct module light in a second direction;
wherein said inner portion of said track is arranged to at least partially accommodate said at least one LED module, and an outer portion is arranged to be mounted to a support surface;
wherein said track comprises at least one elongated translucent optical component for transmitting indirect module light when said LED module is in said first orientation and,
wherein said elongated translucent optical component is arranged in at least a portion of at least one of said first leg portion and said second leg portion

2. The track lighting system according to claim 1, wherein said elongated translucent optical component is a diffuser.

3. The track lighting system according to claim 1, wherein said elongated translucent optical component has a length (Lo) in the longitudinal extension of said track, and wherein Lo≥0.8·Lt.

4. The track lighting system according to claim 1, wherein said base portion of said track is a metal portion.

5. The track lighting system according to claim 1, wherein said first leg portion and/or said second leg portion comprise said elongated translucent optical component and wherein said first leg portion and second leg portion comprise a metal portion.

6. The track lighting system according to claim 1, wherein each of said first leg portion and said second leg portion comprises a first end portion arranged to be attached to said base portion and a second end portion arranged at a distance from said base portion wherein said second end portion, of said first and/or said second leg portion comprises said elongated translucent optical component.

7. The track lighting system according to claim 1, wherein the portion of the track other than said elongated translucent optical component comprises a reflective portion.

8. The track lighting system according to claim 7, wherein said reflective portion has reflectivity of at least 75%.

9. The track lighting system according to claim 1, further comprising a controller for controlling said spatial light distribution and/or said spectral light distribution from a first parameter to a second parameter different from the first parameter.

10. The track lighting system according to claim 9, wherein said first parameter of said spatial light distribution and/or said spectral light distribution is applied when said LED module is in said first orientation and wherein said second parameter of said spatial light distribution and/or second spectral light distribution is applied when said LED module is in said second orientation.

11. The track lighting system according to claim 1, wherein at least 60% of said indirect module light is emitted into said cavity of the track through said open side of the track when said LED module is in said first orientation

12. The track lighting system according to claim 1, wherein said LED module comprises a light exit window arranged to face said inner portion of said track when said LED module in in said first orientation and wherein said light exit window is arranged to face away from said inner portion of said track when said LED module is in said second orientation

13. The track lighting system according to claim 12, wherein said light exit window of said LED module is completely covered by said track when said LED module is in said first orientation

14. A method for controlling a track lighting system comprising:
a power track having a length in a longitudinal extension, said power track comprising a cavity enclosed by a base portion a first leg portion and a second leg portion and having an open side, said track having an inner portion constituted by said cavity wherein said first and said second leg portions are substantially parallel to each other and are connected by said base portion, said first and said second leg portions, having a longitudinal extension being substantially parallel to said longitudinal extension of said power track, and a transversal extension being substantially perpendicular to said longitudinal extension, such that said track has a substantially U-shaped cross-section in a direction being substantially perpendicular to said longitudinal extension, said track comprising electrical and mechanical connection means;
at least one LED module providing module light having a spatial light distribution and a spectral light distribution, wherein said LED module is connectable to said track in a first orientation for providing indirect module light in a first direction and in a second orientation for providing direct module light in a second direction;
wherein said inner portion of said track is arranged to at least partially accommodate said at least one LED module, and an outer portion is arranged to be mounted to a support surface;
wherein said track comprises at least one elongated translucent optical component being arranged in at least a portion of at least one of said first leg portion and said second leg portion said elongated translucent optical component is arranged for transmitting indirect module light when said LED module is in said first orientation said method comprising the steps of:
a) determining whether indirect module light should be provided in a first direction or direct module light should be provided in said second direction;
b) attaching said LED module to said track in either said first orientation or said second orientation depending on the direction of said light determined in step at.
